(19) United States
(12) Patent Application Publication
(10) Pub. No.: US 2024/0296362 A1
(43) Pub. Date: Sep. 5, 2024

(54) PERFORMING UNBIASED FERMIONIC QUANTUM MONTE CARLO CALCULATIONS USING QUANTUM COMPUTERS AND SHADOW TOMOGRAPHY

(71) Applicant: Google LLC, Mountain View, CA (US)

(72) Inventors: William Huggins, Oakland, CA (US); Joonho Lee, New York, NY (US); Ryan Babbush, Mountain View, CA (US)

(21) Appl. No.: 18/574,922

(22) PCT Filed: Jun. 28, 2022
(86) PCT No.: PCT/US2022/035334

§ 371 Date: Dec. 28, 2023

Related U.S. Application Data
(60) Provisional application No. 63/215,842, filed on Jun. 28, 2021.

(51) Int. Cl. G06N 10/20

(52) U.S. Cl. CPC G06N 10/20

(57) ABSTRACT

Methods, systems, and apparatus for hybrid quantum-classical quantum Monte Carlo. In one aspect, a method includes receiving, by a classical computer, data generated by a quantum computer, the data representing results of measurements of a trial wavefunction, wherein the trial wavefunction approximates the target wavefunction and is prepared by the quantum computer, computing, by the classical computer, a classical shadow of the trial wavefunction using the data representing the results of the measurements of the trial wavefunction, and performing, by the classical computer, imaginary time propagation for a sequence of imaginary time steps of an initial wavefunction using a Hamiltonian that characterizes the fermionic quantum system, wherein: the imaginary time propagation is performed until predetermined convergence criteria are met; and performing each imaginary time step of the imaginary time propagation comprises updating the wavefunction for the previous imaginary time step using the classical shadow of the trial wavefunction to obtain a wavefunction for the current imaginary time step.

### BACKGROUND

This specification relates to quantum computing.

Calculating accurate solutions of the Schrödinger equation for the ground state of many-electron systems has applications across nearly all fields of modern science, enabling a detailed understanding of important unsolved questions in chemistry, physics, materials science, and biology. However, the complexity of the Schrödinger equation grows exponentially with the number of electrons in the system. Therefore, progress towards an efficient means of accurately calculating ground state quantum mechanical properties of complex systems has been slow.

Known general-purpose methods for calculating solutions of the Schrödinger equation can be grouped into two categories. A first category includes methods that scale exponentially with system size while yielding numerically exact answers. The second category includes methods with a cost that scales polynomially with system size and rely on the cancellation of errors when computing observables. Approaches of the second category are currently the only methods that can feasibly be applied to large systems, however the accuracy of the solutions obtained in such cases can be unsatisfactory and is nearly always difficult to access.

Quantum computing provides an alternative computational paradigm that can complement and potentially surpass classical methods in terms of efficiency. In the absence of fault-tolerant quantum computers, Noisy Intermediate-Scale Quantum Computing (NISQ) technology can be used to investigate many-body quantum problems. NISQ algorithms for the computation of quantum ground states have been largely centered around the variational quantum eigensolver (VQE) framework, which necessitates coping with optimization difficulties and noisy gradients. As an alternative, algorithms based on imaginary time evolution have been put forward that, in principle, avoid the optimization problem. However, due to the non-unitary nature of imaginary time evolution, optimization heuristics must be used in order to achieve reasonable scaling with system size. An alternative computational strategy which avoids these limiting factors is therefore needed to enable the first practical quantum advantage in fermionic simulations.

### SUMMARY

This specification describes a quantum-classical hybrid algorithm for performing unbiased fermionic quantum Monte Carlo calculations using quantum computers and shadow tomography.

In general, one innovative aspect of the subject matter described in this specification can be implemented in a method for performing a Quantum Monte Carlo simulation of a fermionic quantum system to compute a target wavefunction of the fermionic quantum system, the method comprising: receiving, by a classical computer, data generated by a quantum computer, the data representing results of one or more measurements of a transformed trial wavefunction, wherein the trial wavefunction approximates the target wavefunction and is prepared by the quantum computer; computing, by the classical computer, a classical shadow of the trial wavefunction using the data representing the results of the one or more measurements of the transformed trial wavefunction; and performing, by the classical computer, imaginary time propagation for a sequence of imaginary time steps of an initial wavefunction using a Hamiltonian that characterizes the fermionic quantum system, wherein: the imaginary time propagation is performed until predetermined convergence criteria are met; and performing each imaginary time step of the imaginary time propagation comprises updating the wavefunction for the previous imaginary time step using the classical shadow of the trial wavefunction to obtain a wavefunction for the current imaginary time step.

Other implementations of these aspects includes corresponding computer systems, apparatus, and computer programs recorded on one or more computer storage devices, each configured to perform the actions of the methods. A system of one or more classical and/or quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations updating the wavefunction for the previous imaginary time step using the classical shadow of the trial wavefunction comprises: determining walker wavefunctions for the current imaginary time step; and determining walker weights for a current imaginary time step using a first inner product of the trial wavefunction and walker wavefunctions for the previous imaginary time step and a second inner product of the trial wavefunction and walker wavefunctions for a current imaginary time step, wherein the first inner product and second inner product are determined using the classical shadow of the trial wavefunction.

In some implementations the method further comprises storing the computed classical shadow of the trial wavefunction in a classical memory of the classical computer.

In some implementations determining walker weights for a current imaginary time step using the first inner product of the trial wavefunction and walker wavefunctions for the previous imaginary time step and the second inner product of the trial wavefunction and walker wavefunctions for a current imaginary time step comprises: retrieving the classical shadow of the trial wavefunction from the classical memory; computing an approximation of the first inner product, comprising determining expectation values of one or more classically simulated first projectors and the classical shadow of the trial wavefunction, wherein the one or more first projectors are dependent on the walker wavefunctions for the previous imaginary time step; and computing an approximation of the second inner product, comprising determining expectation values of one or more classically simulated second projectors and the classical shadow of the trial wavefunction, wherein the one or more second projectors are dependent on the walker wavefunctions for the current imaginary time step.

In some implementations the one or more first projectors are generated using stabilizer states.

In some implementations the stabilizer states comprise a computational basis state with a Hamming weight equal to the number of particles represented by the trial state.

In some implementations the transformed trial wavefunction comprises a trial wavefunction rotated using a unitary operator randomly sampled from an ensemble of unitaries, wherein the ensemble of unitaries is tomographically complete.

In some implementations the unitary operator comprises an N-qubit Clifford circuit or a tensor product of randomly selected Clifford circuits on less than N qubits.

In some implementations performing each imaginary time step of the imaginary time propagation further comprises computing an energy estimator using the classical shadow of the trial wavefunction.

In some implementations the transformed trial wavefunction comprises a trial wavefunction transformed using a tensor product of unitary operators, wherein each unitary operator in the tensor product comprises a respective randomly selected N_{p∈P}-qubit Clifford gate, wherein N_{p∈P} represents a number of qubits in part p of a partitioning of N qubits into P parts.

In some implementations the Quantum Monte Carlo simulation comprises an Projector Quantum Monte Carlo simulation or an Auxiliary-field Quantum Monte Carlo simulation.

In some implementations the quantum computer comprises a Noisy Intermediate Scale Quantum device.

In some implementations the trial wavefunction comprises a wavefunction from a generalized valence bond perfect-pairing wavefunction ansatz.

In some implementations the generalized valence bond perfect-pairing wavefunction ansatz comprises a first set of layers comprising density-density product terms and a second set of layer comprising nearest-neighbor hopping terms between same spin pairs.

The subject matter described in this specification can be implemented in particular ways so as to realize one or more of the following advantages.

A system implementing the presently described techniques can target quantum states and properties thereof with improved computational efficiency and improved accuracy. For example, in the present hybrid quantum classical quantum Monte Carlo algorithm, there is no need for the classically performed quantum Monte Carlo calculation to iteratively query the quantum computer. By separating the interaction between the quantum and classical computers in this manner, the need to minimize the latency is avoided—an especially appealing feature on NISQ platforms.

In addition, a system implementing the presently described techniques uses trial wavefunctions that are inherently more accurate than conventional trial wavefunctions, e.g., single determinants, and can be obtained by an efficient polynomially scaling classical approach that bypasses the difficulty of variational optimization on the quantum computer. The trial wavefunctions can include wavefunctions for which no known polynomial-scaling classical algorithm exists for the evaluation of quantities required by the quantum Monte Carlo calculations. The trial wavefunctions achieve polynomial scaling and therefore the presently described techniques achieve an exponential computational speed-up compared to classical counterparts.

In addition, a system implementing the presently described techniques can compute quantities required by the quantum Monte Carlo calculations, e.g., wavefunction overlaps, with a bounded number of experiment and measurement repetitions (without restrictions on the form of the trial wavefunction). This number is of the order

$$O ( \frac{1}{{ϵ}^{2}} )$$

(where ∈ is the error in the calculations). Therefore, the techniques are particularly suitable for implementations on a near-term quantum computer.

In addition, the presently described techniques are robust to noise, e.g., noise resulting from hardware imperfections, because the quantity that is directly computed is the ratio between overlap values, which is inherently resilient to the overlaps being rescaled by certain error channels.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system performing a quantum-classical hybrid QMC algorithm.

FIG. 2 is a flow diagram of a first example process for performing a Quantum Monte Carlo simulation of a fermionic quantum system to compute a target wavefunction of the fermionic quantum system and/or properties of the target wavefunction using shadow tomography.

FIG. 3 shows an application of the presently described QC-QMC algorithm to an H₄ molecule in an 8-qubit experiment.

FIG. 4 is a flow diagram of a second example process for performing a Quantum Monte Carlo simulation of a fermionic quantum system to compute a target wavefunction of the fermionic quantum system and/or properties of the target wavefunction.

FIG. 5 depicts an example classical/quantum computer.

### DETAILED DESCRIPTION

Quantum Monte Carlo (QMC) approaches target an exact quantum state |Ψ₀ [symbol] , e.g., a ground state, of a many-body Hamiltonian Ĥ via imaginary time evolution of an initial state |Φ₀ [symbol] that has a non-zero overlap with |Ψ₀ [symbol] , as given by Eq. 1 below.

$$\vert {Ψ}_{0} 〉 ∝ {lim}_{τ \to ∞} \vert Ψ ( τ ) 〉 , \vert Ψ ( τ ) 〉 ≡ exp \{ ( - τ \hat{H} ) \} \vert {Φ}_{0} 〉 , \qquad ( 1 )$$

In Eq. 1, r represents imaginary time and |Ψ(τ) [symbol] represents the time-evolved wavefunction from |Ψ₀ [symbol] by τ. Without any further modification, this is an exact approach to the computation of the target state |Ψ₀ [symbol] . In practice, a deterministic implementation of Eq. 1 scales exponentially with system size. Therefore, conventional techniques resort to a stochastic realization of Eq. 1 for scalable simulations, e.g., polynomial-scaling simulations that sample an estimate for the exact ground state energy by avoiding the explicit storage of high dimensional objects such as Ĥ and |Ψ₀ [symbol] . Such stochastic realizations are sometimes referred to as projector QMC (PQMC).

The ground state energy of the target state, E_{ground}=E(τ=∞), can be estimated by averaging a time series of {(E(τ) [symbol] }, given by a weighted average over M statistical samples,

$$〈 E ( τ ) 〉 = {{\sum }^{M}}_{i = 1} {w}_{i} ( τ ) {E}^{( i )} ( τ ) , \qquad ( 2 )$$

where E⁽ⁱ⁾(τ) represents the i-th statistical sample for the energy and wᵢ(τ) represents the corresponding normalized weight for that sample at imaginary time τ.

While formally exact, such a stochastic imaginary time evolution algorithm will generically run into the notorious fermionic sign problem, which manifests due to alternating signs in the weights of each statistical sample. In the worst case, the fermionic sign problem causes the estimator of the energy to have exponentially large variance, necessitating the need to average over exponentially many samples to obtain a fixed precision estimate of observables such as the ground state energy. Accordingly, reliable computation of the ground state and properties thereof are practically unfeasible and exact, unbiased QMC approaches are only applicable to small systems or those lacking a sign problem.

In first quantization QMC methods, this problem renders as the bosonic ground state. Because the fermionic anti-symmetry is not imposed explicitly the true ground state of a first-quantized Hamiltonian is in fact bosonic. This then requires imposing the fermionic nodal structure in first quantization to compute the fermionic ground state. In second quantization QMC methods, bosonic states cannot be obtained from a fermionic Hamiltonian. The sign problem manifests in a different way. The statistical estimates from a second quantization QMC method exhibit variances that grow exponentially with system size.

The sign problem can be controlled to give an estimator of the ground state energy with polynomially bounded variance by imposing constraints on the imaginary time evolution of each statistical sample represented by a respective wavefunction, |ϕᵢ(τ) [symbol] . These constraints, e.g., fixed node and phaseless approximations, can be imposed by the use of trial wavefunctions |Ψ_{T} [symbol] , and the accuracy of constrained QMC is determined by the choice of the trial wavefunction. Such constraints necessarily introduce a potentially significant bias in the final ground state energy estimate.

Classically, computationally tractable options for trial wavefunctions are limited to states such as a single mean-field determinant, e.g. a Hartree-Fock state, a linear combination of mean-field states, a simple form of the electron-electron pair (two-body) correlator (usually called a Jastrow factor) applied to mean-field states, or some other physically motivated transformations applied to mean-field states such as backflow approaches. On the other hand, wavefunctions that can be prepared with quantum circuits are candidates for trial wavefunctions on a quantum computer, including more general two-body correlators. These trial wavefunctions are referred to herein as “quantum” trial wavefunctions.

This specification describes a hybrid quantum-classical Quantum Monte Carlo (QMC) algorithm that combines constrained QMC with quantum computing techniques to reduce biases in a final quantum state estimate. The quantum-classical hybrid QMC algorithm (QC-QMC) utilizes quantum trial wavefunctions while performing the majority of imaginary time evolution on a classical computer. That is, a classical computer performs imaginary time evolution of each statistical sample |ϕᵢ(τ) [symbol] and collects observables such as the ground state energy estimate E⁽ⁱ⁾(τ). During this procedure, me constraint via a quantum trial wavefunction is imposed to control the sign problem.

To perform the constrained time evolution, the only primitive that requires a quantum computer is the computation of the overlap between the trial wavefunction |Ψ_{T} [symbol] and the statistical sample wavefunction |ϕᵢ(τ) [symbol] at arbitrary imaginary time r. In particular, the presently described QC-QMC algorithm estimates the overlap between the trial wavefunction and the statistical samples using shadow tomography. Experimentally, this includes performing a randomly chosen set of measurements of a reference state related to the trial wavefunction prior to beginning the QMC calculation. This allows for an efficient estimation of the entire set of required overlaps using a modest number of experimental repetitions combined with classical post-processing. There is no need for the classically performed QMC calculation to iteratively query the quantum computer in this formulation of QC-QMC, despite the fact that the details of the statistical samples are not determined ahead of time. By separating the interaction between the quantum and classical computers the need to minimize the latency is avoided—an especially appealing feature on NISQ platforms.

The presently described QC-QMC algorithm applies generally to any form of constrained QMC, however for illustrative purposes this specification describes a specific demonstration of the QC-QMC algorithm that uses an implementation of QMC known as auxiliary-field QMC (AFQMC). AFQMC is a PQMC method that works in second-quantized space. Therefore, the sign problem in AFQMC manifests in growing variance in statistical estimates. To impose a constraint in the imaginary-time propagation, a trial wavefunction that can be used in the importance sampling as well as the constraint is introduced. This results in a wavefunction at imaginary time τ written as

$$\vert Ψ ( τ ) 〉 = {\sum }_{i} {w}_{i} ( τ ) \frac{\vert {ϕ}_{i} ( τ ) 〉}{〈 {Ψ}_{T} \vert {ϕ}_{i} ( τ ) 〉} \qquad ( 3 )$$

where |ϕᵢ(τ) [symbol] represents a wavefunction of an i-th walker, wᵢ(τ) is a weight of an i-th walker, and |Ψ_{T} [symbol] is an a priori chosen trial wavefunction. In some implementations the trial wavefunction can be a singe mean-field trial wavefunction (which has a polynomial-scaling cost) or can be a linear combination of mean-field states (which ultimately scales exponentially with system size due to the exponential growth of the number of important mean-field states). From Eq. 3 it is evident that the importance sampling is imposed based on the overlap between the walker wavefunction and the trial wavefunction.

In some implementations the walker wavefunctions in Eq. 3 can be chosen to be a single Slater determinant and the action of the imaginary propagation, exp{(−ΔτĤ)} for a small time step Δτ, in Eq. 1 enables these wavefunctions to stay in the single Slater determinant manifold via the Hubbard-Stratonovich transformation. This property enables the computational cost to grow only polynomially with system size.

While repeatedly applying the imaginary time propagation to the wavefunction, the AFQMC algorithm prescribes a particular technique to update the walker weight wᵢ(τ) in Eq. 3 so that all weights stay real and positive and the final energy estimator,

$$E ( τ ) = \frac{〈 {Ψ}_{T} \vert \hat{H} \vert Ψ ( τ ) 〉}{〈 {Ψ}_{T} \vert Ψ ( τ ) 〉} = \frac{{\sum }_{i} {w}_{i} {E}^{( i )} ( τ )}{{\sum }_{i} {w}_{i}} \qquad ( 4 )$$

has a small variance. In Eq. 4, E⁽ⁱ⁾(τ) represents the local energy and is defined as

$${E}^{( i )} ( τ ) = \frac{〈 {Ψ}_{T} \vert \hat{H} \vert {ψ}_{i} ( τ ) 〉}{〈 {Ψ}_{T} \vert {ψ}_{i} ( τ ) 〉} .$$

Eq. 4 is referred to as the “mixed” energy estimator in QMC. The constraint specifies that the n-th walker weight is updated from τ to τ+Δτ using

$$\vert {S}_{i} ( τ ) \vert \times max ( 0 , cos {θ}_{i} ( τ ) ) \qquad ( 5 )$$

$$where$$

$${S}_{i} ( τ ) = \frac{〈 {Ψ}_{T} \vert {ϕ}_{i} ( τ + Δτ ) 〉}{〈 {Ψ}_{T} \vert {ϕ}_{i} ( τ ) 〉} \qquad ( 6 )$$

and θᵢ(τ) represents the argument of Sₙ(τ). This is in contrast with a typical importance sampling strategy which updates the walker weight just using Sᵢ(τ), which does not guarantee the positivity and reality of the walker weights. If |Ψ_{T} [symbol] is exact, this constraint does not introduce any bias, but imposes a specific boundary condition to a imaginary propagation which can be viewed as a “gauge-fixing” of the wavefunction. In practice, the trial function |Ψ_{T} [symbol] is not exact and therefore an approximate energy is computed using the AFQMC calculations, with an accuracy that depends on the choice of |Ψ_{T} [symbol] . Such a constraint is usually referred to as the “phaseless approximation” in the AFQMC literature.

Currently, classically tractable trial wavefunctions are either a single determinant or a linear combination of determinants. The former is scalable (up to 500 electrons or so) but can be often inaccurate especially for strongly correlated systems. The latter is limited to a small number of electrons (14 or so) but can be made very accurate even for strongly correlated systems. The choice of trial wavefunctions in AFQMC is limited by the evaluation of Eq. 4 and Eq. 6. If the computation of either one of these scales exponentially with system size, the resulting AFQMC calculation will be exponentially expensive.

The presently described QC-QMC algorithm uses a class of trial wavefunctions that are inherently more accurate than a single determinant and can be obtained by an efficient polynomially scaling classical approach that bypasses the difficulty of variational optimization on the quantum computer. The trial wavefunctions can include wavefunctions for which no known polynomial-scaling classical algorithm exists for the evaluation of Eq. 4 and Eq. 6. Quantum computers are used to remove such limitations through the introduction of polynomial-scaling algorithms for Eq. 4 and Eq. 6 and thereby this guarantees an exponential speed-up compared to the classical counterpart. In the presently described QC-QMC algorithm, Eq. 4 and Eq. 6 can be measured on quantum computers and the actual imaginary time propagation can be implemented classically. This separates subroutines into those that need to be run on quantum computers and those on classical computers.

In some implementations the trial wavefunction can be a variant of a coupled-cluster wavefunction. Coupled-cluster wavefunctions are characterized by an exponential parametrization,

$$\vert Ψ 〉 = {e}^{\hat{T}} \vert {ψ}_{0} 〉 \qquad ( 7 )$$

where |ψ₀ [symbol] is a reference single determinant and the cluster operator \hat{T} is given by

$$\hat{T} = {\sum }_{a i} {t}_{i}^{a} {a}_{a}^{†} {a}_{i} + {\sum }_{i j a b} {t}_{i j}^{a b} {a}_{b}^{†} {a}_{a}^{†} {a}_{j} {a}_{i} + \qquad ( 8 )$$

where {i, j, k, . . . } represent occupied orbitals and {a, b, c, . . . } represent unoccupied orbitals. \hat{T} can be extended to include single excitations (S), double excitations (D), triple excitations (T) and so on. The resulting coupled-cluster wavefunction is then systematically improvable by including higher excitations. A widely used wavefunction involves up to doubles and is referred to as coupled-cluster with singles and doubles (CCSD). There is currently no efficient algorithm for variationally determining the coupled-cluster amplitudes, t. However, there is an efficient projective method to determine these amplitudes and energy although the resulting energy is not variational. Such non-variationality easily manifests as a breakdown of conventional coupled-cluster, but the underlying wavefunction is still qualitatively correct and the projective energy evaluation is the cause of this.

Using CCSD (or other higher-order coupled-cluster wavefunctions) is unsuitable for use as AFQMC trial wavefunctions because their projection onto an arbitrary Slater determinant cannot be calculated efficiently without approximation. This is true for nearly all non-trivial variants of coupled cluster. The cost of calculating wavefunction overlaps even for coupled cluster methods with a limited set of amplitudes such as generalized valence bond perfect-pairing (PP)^{1,2}, scales exponentially with system size. The required overlaps of such wavefunctions can be efficiently evaluated by using a quantum computer to prepare a unitary version of coupled-cluster wavefunctions, or approximations to them. The use of coupled-cluster wavefunctions that can be optimized classically avoids costly variational optimization procedures on the quantum device.

An example coupled-cluster wavefunction ansatz that can be used as a trial wavefunction is the generalized valence bond PP ansatz. This ansatz is defined as

$$\vert {Ψ}_{P P} 〉 = {e}^{{\hat{T}}_{P P}} {e}^{\hat{κ}} \vert {ψ}_{0} 〉 \qquad ( 9 )$$

where the orbital rotation operator is defined as

$$\hat{κ} = {\sum }_{p q}^{{N}_{orbitals}} ( {κ}_{p q}^{↑} - {κ}_{q p}^{↑} ) {\hat{a}}_{{p}_{↑}}^{†} {\hat{a}}_{{q}_{↑}} + ( {κ}_{p q}^{↓} - {κ}_{q p}^{↓} ) {\hat{a}}_{{p}_{↓}}^{†} {\hat{a}}_{{q}_{↓}} \qquad ( 10 )$$

and the PP cluster operator is

$${\hat{T}}_{P P} = {\sum }_{i}^{{N}_{pairs}} {t}_{i} {\hat{a}}_{{i}_{↑}^{*}}^{†} {\hat{a}}_{{i}_{↑}} {\hat{a}}_{{i}_{↓}^{*}}^{†} {\hat{a}}_{i} \qquad ( 11 )$$

In this equation, each i is an occupied orbital and each i* is the corresponding virtual orbital that is paired with the occupied orbital i. The spin-orbitals of this wavefunction can be mapped to qubits using the Jordan-Wigner transformation. It is noted that the pair basis in tᵢ is defined in the new rotated orbital basis defined by the orbital rotation operator. The PP wavefunction has particularly suitable for understanding chemical processes mainly due to its natural connection with valence bond theory which often provides a more intuitive chemical picture than does molecular orbital theory.

The PP wavefunction often becomes insufficient in achieving qualitative accuracy. This is best shown in systems where inter-pair correlation becomes important such as multiple bond breaking. There are some ways to incorporate those inter-pair correlation classically, but in the presently described QC-QMC multiple layers of hardware-efficient operators can be added to the PP ansatz. There are two kinds of these additional layers that can be added:
1. The first kind of layers includes only density-density product terms:

$${e}^{{J}_{ij} {\hat{n}}_{i} {\hat{n}}_{j}} \qquad ( 12 )$$

It is noted that every operator in this layer commutes with one another so that there is no Trotter error.
2. The second kind includes only “nearest-neighbor” hopping terms between same spin (σ) pairs:

$${e}^{{Q}_{ij} {â}_{{i}_{σ}}^{†} {â}_{{j}_{σ}} - {Q}_{ij}^{*} {â}_{{j}_{σ}}^{†} {â}_{{i}_{σ}}} \qquad ( 13 )$$

where i and j orbitals are physically neighboring in the hardware layout.

Multiple layers of each kind can be alternated and applied to the PP ansatz to improve the overall accuracy. The efficacy of these layers varies with the choice of i, j pairs.

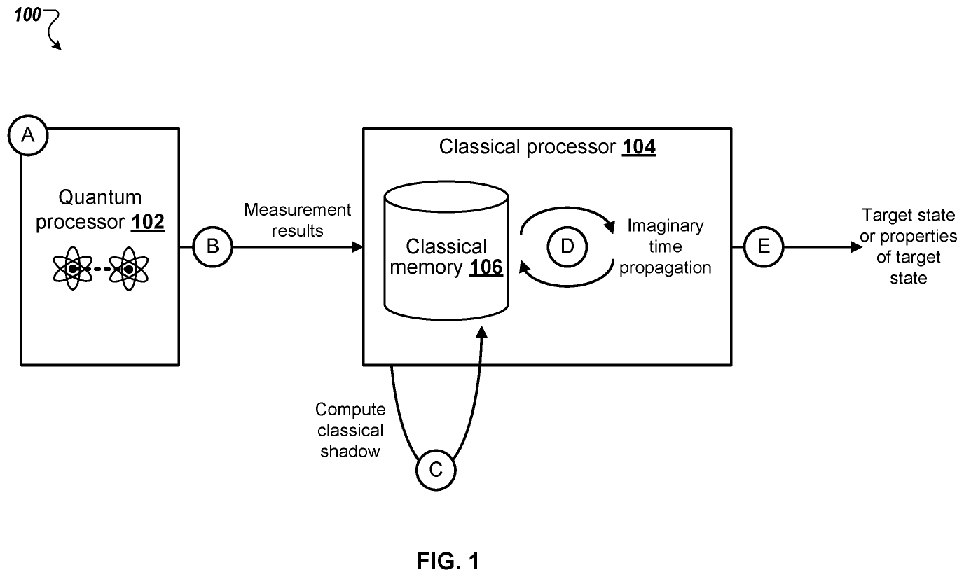

FIG. 1 is a block diagram of an example system 100 performing the presently described QC-QMC algorithm. The system 100 is an example of a system implemented as quantum and classical computer programs on quantum computing devices and classical computers in one or more locations, in which the systems, components, and techniques described below can be implemented.

The example system 100 includes a quantum processor 102 in data communication with a classical processor 104. For illustrative purposes, the quantum processor 102 and classical processor 104 are shown as separate entities, however in some implementations the classical processor 104 may be included in quantum processor 102.

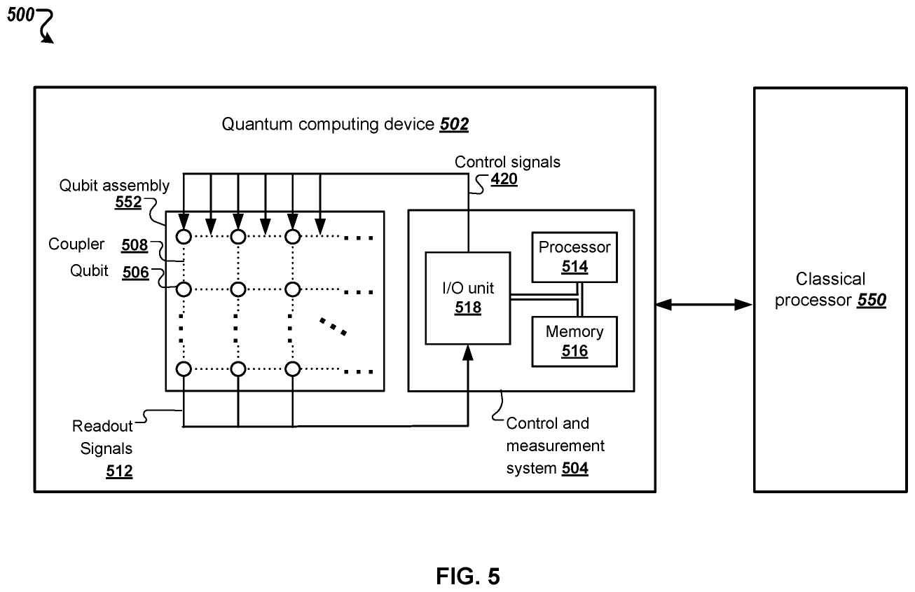

The quantum processor 102 includes components for performing quantum computation. For example, the quantum processor 102 can include a qubit array, quantum circuitry, and control devices configured to operate physical qubits in the qubit array and apply quantum circuits to the qubits. An example quantum processor is described in the more detail below with reference to FIG. 5.

The classical processor 104 includes components for performing classical computation. For example, the classical processor 104 can be configured to transmit data specifying trial wavefunctions to the quantum processor 104, and receive data representing results of measurement operations performed by the quantum processor 104. The classical processor 104 can further be configured to process received data representing results of measurement operations performed by the quantum processor 104 to compute a classical representation of a target state or properties of the target state.

As described above, the presently described QC-QMC algorithm performs QMC imaginary time evolution using shadow tomography. Shadow tomography is a process that can be used to estimate properties of a quantum state without resorting to full state tomography. Let ρ denote some unknown quantum state. It is assumed that access to N copies of ρ is possible. Let {Oᵢ} denote a collection of M observables. The task is to estimate the quantities Tr(ρOᵢ) up to some additive error a for each Oᵢ. This can be accomplished efficiently in certain circumstances by randomly choosing measurement operators from a tomographically complete set, i.e. a set that forms an operator basis on the Hilbert space of the system.

To specify a protocol, an ensemble of unitaries [symbol] is chosen. Then, unitaries Uₖ∈ [symbol] are randomly sampled and the state UₖρUₖ^{†} is measured in the computational basis to obtain the basis state |bₖ [symbol] [symbol] bₖ|. Now, consider the state Uₖ^{†}|bₖ [symbol] [symbol] bₖ|Uₖ. In expectation, the mapping from ρ to this state defines a quantum channel,

$$ℳ ( ρ ) := {𝔼}_{k} [ {U}_{k}^{†} \vert {b}_{k} 〉 〈 {b}_{k} \vert {U}_{k} ] \qquad ( 14 )$$

It is required that [symbol] be invertible, which is true if and only if the collection of measurement operators defined by drawing U∈ [symbol] and measuring in the computational basis is tomographically complete. Assuming that this is true, [symbol] can be applied to both sides of Eq. 14, yielding

$$ρ = {ℳ}^{- 1} ( {𝔼}_{k} [ {U}_{k}^{†} \vert {b}_{k} 〉 〈 {b}_{k} \vert {U}_{k} ] ) = {𝔼}_{k} [ {ℳ}^{- 1} ( {U}_{k}^{†} \vert {b}_{k} 〉 〈 {b}_{k} \vert {U}_{k} ) ] \qquad ( 15 )$$

The collection { [symbol] (Uₖ^{†}|bₖ [symbol] [symbol] bₖ|Uₖ)} is the classical shadow of ρ. Many choices for the ensemble [symbol] are possible. For example, randomly selected N-qubit Clifford circuits, as well as tensor products of randomly selected Clifford circuits on fewer qubits can be used.

Therefore, at stage (A) of the QC-QMC algorithm, the quantum processor 102 performs a randomly chosen set of measurements of copies of a trial wavefunction for the QMC calculation. That is, the quantum processor 102 performs multiple experiments to measure the quantum states Uₖ^{†}|bₖ [symbol] [symbol] bₖ|Uₖ and collect corresponding measurement data. At stage (B) of the QC-QMC algorithm, the quantum processor 102 transmits the collected measurement data to the classical processor 104, so that the classical processor 104 can perform a QMC algorithm. Stages (A) and (B) can be performed in advance of QMC algorithm.

To each experiment of the multiple experiments, the quantum processor 102 can apply quantum circuits to physical qubits included in the quantum processor 102. The circuits can include a first circuit that prepares the qubits in an initial state, e.g., a superposition of the trial wavefunction and the zero state, and a second quantum circuit that implements the measurement operator for the shadow tomography experiment. The specific form of the first and second circuit depend on the trial wavefunctions being used.

As an example, in implementations where the trial wavefunctions are perfect pairing states (PP), the first circuit is a quantum circuit that prepares the quantum state |τ [symbol] =(|0)+|Ψ_{T} [symbol] )/√2. In this example, it is sufficient to prepare the quantum state (|0 [symbol] +|PP(θ) [symbol] )/√2 where |PP(θ) [symbol] represents a perfect pairing state with a vector of state parameters θ and is given by |PP(θ) [symbol] =⊗ᵢ₌₁^{N/4} PP(θᵢ) [symbol] with N the number of spin orbitals. This quantum state can be prepared by creating the state (|0 [symbol] +|0000)^{⊗N/4})/√2 using quantum circuit that includes a single-qubit Hadamard and a ladder of CNOT and SWAP gates. Then, for each set of 4 qubits corresponding to a pair of spatial orbitals the state |PP(θ) [symbol] =cos θ|1100 [symbol] +sin θ|0011 [symbol] ∝CNOT_{1,2}CNOT_{3,4}(iSWAP_{1,3})^{θ}|1000 [symbol] where the CNOTS and iSWAP gates leave the zero part of the state unchanged.

In this example, for the second quantum circuit, the measurement operators have the form

$$G ( I , Γ , Δ ) = \prod \text{?} {H}_{i} P \text{?} \prod \text{?} CZ \text{?} \prod \text{?} CX \text{?} .$$

$$\text{?} \text{indicates text missing or illegible when filed}$$

which can be written as

$$G ( I , Γ , Δ ) = H \text{?} \prod \text{?} P \text{?} \prod \text{?} CZ \text{?} \prod \text{?} H \text{?} .$$

$$\text{?} \text{indicates text missing or illegible when filed}$$

This operator can be achieved through application of a CZ layer sandwiched by two layers of single-qubit gates. A CZ layer followed by complete reversal of the qubits can be implemented using a circuit of 2n+2 CNOT layers (plus intervening layers of single qubit powers of P). Because the CZ layer in the circuit for G is followed only by single-qubit gates and measurement in the computational basis, the reversal of qubits can be easily undone in post-processing. Thus the shadow tomography circuits in this example have a 2-qubit gate depth of at most 2n+2. This is a significant improvement over using the full Clifford group for shadow tomography—the best known circuit for a general Clifford has 2-qubit depth 9n. Furthermore, the CZ circuits have the additional properties that they contain only four unique CNOT layers and that they act only along a line, which are advantageous for calibration and qubit mapping, respectively.

In some implementations, the following global stabilizer measurement strategy can be implemented to reduce the size of quantum circuits required to perform shadow tomography. In general, applying a unitary U and then measuring in the computational basis {|x [symbol] :x∈{0,1}ⁿ}, as shadow tomography was originally presented is equivalent to measuring in the rotated basis {U^{†}|x [symbol] :x∈{0,1}ⁿ}. For a set of unitaries [symbol] , choosing a unitary therefrom uniformly at random and then measuring in the computational basis is equivalent to measuring the POVM

$$\{ \frac{1}{\vert 𝒰 \vert} {U}^{†} \vert x 〉 〈 x \vert U : x ∈ {\{ 0 , 1 \}}^{n} , U ∈ 𝒰 \} .$$

Note that the | [symbol] |2ⁿ measurement operators need not be distinct (e.g., if the unitaries in [symbol] only permute the computational basis states). In particular, when [symbol] is the set of n-qubit Clifford unitaries [symbol] ₙ, each measurement U^{†}|x [symbol] [symbol] x|U is a stabilizer state, and the POVM is

$$\{ \frac{{2}^{n}}{\vert {stab}_{n} \vert} \vert ψ 〉 〈 ψ \vert : \vert ψ 〉 ∈ {stab}_{n} \} \qquad ( 16 )$$

where stabₙ represents the set of N qubit stabilizer states. That the weight of the measurement operators is uniform follows from the symmetry of [symbol] (appending any Clifford to each U∈ [symbol] leaves the distribution unchanged); that the uniform weight is

$$\frac{{2}^{n}}{\vert {stab}_{n} \vert}$$

is explained below. There are | [symbol] ₙ|=2ⁿ^{²}⁺²^{ⁿ}Πᵢ₌₁ⁿ(4ⁱ−1) Clifford unitaries and only 2ⁿ Πᵢ₋₁ⁿ(2ⁱ+1)<<2ⁿ| [symbol] ₙ|, stabilizer states. This suggests that sampling a uniformly random Clifford is unnecessary. A smaller set of 2⁻ⁿ|stabₙ| unitaries [symbol] ₙ is constructed such that the corresponding POVM is equivalent to that of [symbol] ₙ. Specifically, stabₙ={U^{†}|x [symbol] :U∈ [symbol] ₙ, x∈{0,1}ⁿ}.

Let [symbol] be the “H-free” group on n qubits, i.e. the group generated by X, CNOT, CZ. The action of any H-free operator can be written as

$$F ( Γ , γ , Δ , δ ) \vert x 〉 = {{i}^{{x}^{T} Γ x} ( - 1 )}^{γ . x} \vert Δ x + δ 〉 \qquad ( 17 )$$

where Γ is 0-1 symmetric matrix; γ, δ∈{0,1}ⁿ and Δ is an invertible 0-1 matrix. The action of an H-free operator thus is to permute the basis states and add some phase. If the computational basis is used as a measurement basis, the phase doesn't affect the outcome probabilities and the affine change x [symbol] Δx+δ is invertible. Therefore measuring a state in the computational basis and applying the transformation y [symbol] Δ⁻¹(y+δ) to the outcome y is equivalent to applying F and then measuring in the computational basis. Any Clifford operator can be written in the form F·H·F′, where F, F′∈ [symbol] and H is a layer of single-qubit Hadamards. In shadow tomography, a Clifford F·H·F′ is applied and the result is measured in the computational basis. As explained above, however, the second H-free operator F need not actually be applied; its effect can be implemented entirely in classical post-processing. In general, F and F′ are not unique. However, a canonical form for Clifford operators (by constraining the H-free operators F, F′) that allows for uniform sampling can be obtained. Starting with their canonical form and “pushing” as much of F′ through the Hadamard layer into F, yielding a new form \tilde{F}·H·\tilde{F}′=F·H·F′, and neglecting the new final H-free operator \tilde{F}, gives an operator of the form;

$$G ( I , ΓΔ ) = {\prod }_{i ∈ I} {H}_{i} {P}_{i}^{{Γ}_{i , i}} {\prod }_{{i ∈ I}_{j ∈ I : j \neq i}} C {Z}_{i , j}^{{Γ}_{i , j}} {\prod }_{{i ∈ I}_{j ∉ I : j > i}} {CX}_{i , j}^{{Δ}_{i , j}} \qquad ( 18 )$$

where I⊂[n] is a subset of qubit indices, Γ is a 0-1 upper-triangular matrix with support only on I, and Δ is a 0-1; that is, Δ and Γ are unconstrained on the entries that appear in Eq. 18 and zero elsewhere. Applying a Clifford operator and measuring in the computational basis can thus be replaced by applying an operator of the form in Eq. 18 and measuring in the computational basis. That is, the fact that measurements in the computational basis are performed immediately after performing a randomly sampled Clifford operator is leveraged such that any permutation of the computational basis states that occurs immediately prior to measurement is unnecessary. This reduces the size of the quantum circuits required to perform shadow tomography.

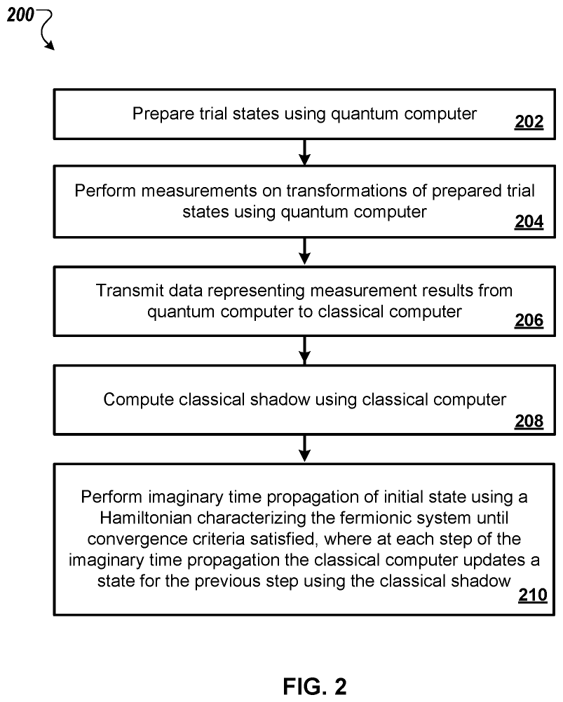

In addition, in some implementations a partitioned shadow tomography strategy can be implemented to reduce quantum circuit depth. This strategy is described in detail below with reference to FIG. 2.

At stage (C) of the QC-QMC algorithm, the classical processor processes the received measurement results and computes a classical shadow. The classical shadow can be stored in a classical memory 106 of the classical processor 104.

At stage (D) of the QC-QMC algorithm, the classical processor 104 performs the QMC algorithm using the stored classical shadow. That is, the classical processor 104 performs imaginary time propagation for a sequence of imaginary time steps of an initial wavefunction using a Hamiltonian that characterizes the fermionic quantum system, e.g., according to Eq. 1. At each imaginary time step, the classical processor uses the stored classical shadow to compute required wavefunction overlaps. Example operations performed by the classical processor 104 are described in more detail below with reference to FIG. 2.

At stage (E) of the QC-QMC algorithm, the classical processor 104 outputs data representing the target quantum state. In some implementations the classical processor 104 can use the data representing the target quantum state to compute properties of the target quantum state, e.g., an expected energy of the target quantum state, as described above with reference to Eq. 2 and Eq. 4-6.

FIG. 2 is a flow diagram of an example process 200 for performing a quantum Monte Carlo simulation of a fermionic quantum system to compute a target wavefunction of the fermionic quantum system and/or properties of the target wavefunction, e.g., a ground state energy. For convenience, the process 200 will be described as being performed by a system that includes classical and quantum computing devices located in one or more locations. For example, system 100 of FIG. 1, appropriately programmed in accordance with this specification, can perform the process 200.

The system uses a quantum computing device to prepare multiple copies of a trial wavefunction (step 202). The trial wavefunction is a wavefunction that approximates the target wavefunction. In some implementations, the trial wavefunction can be a wavefunction from a generalized valence bond perfect-pairing wavefunction ansatz, e.g., where the generalized valence bond perfect-pairing wavefunction ansatz comprises a first set of layers comprising density-density product terms and a second set of layer comprising nearest-neighbor hopping terms between same spin pairs.

The system uses the quantum computing device to perform measurement operations on the multiple copies of the trial wavefunctions (step 204). In some implementations, to perform a measurement operation, the quantum computing device generates a transformed trial wavefunction by rotating the trial wavefunction using a unitary operator randomly sampled from an ensemble of unitaries, where the ensemble of unitaries is tomographically complete. The unitary operator used can be an N-qubit Clifford circuit or a tensor product of randomly selected Clifford circuits on less than N qubits. For example, the transformed trial wavefunction can be given by UₖρUₖ^{†}, as described above in the discussion around Eq. 14. The quantum computing device can then measure the rotated trial wavefunction in the computational basis to obtain a respective measurement result. This process can be repeated for each copy of the trial wavefunction.

In some implementations the system can partition qubits included in the quantum computing device, as described below with reference to Eq. 29-34. In these implementations the system can transform the trial wavefunction by applying a tensor product of unitary operators to the trial wavefunction, where each unitary operator in the tensor product is a respective randomly selected N_{p∈P}-qubit Clifford gate, wherein N_{p∈P} represents a number of qubits in part p of a partitioning of N qubits into P parts, as described below with reference to Eq. 29-34. The quantum computing device can then measure the transformed trial wavefunction in the computational basis to obtain a respective measurement result.

The system transmits data representing results of the measurement operations from the quantum computing device to a classical computing device included in the system (step 206).

The classical computing device receives the data representing the results of the measurements of the transformed trial wavefunctions generated by the quantum computing device and uses the data to compute a classical shadow of the trial wavefunction (step 208). Computing a classical shadow is described above with reference to Eq. 13 and 14. The classical computing device can efficiently store the computed classical shadow in a classical memory of the classical computing device.

The system uses the classical computing device to perform imaginary time propagation (for a sequence of imaginary time steps) of an initial wavefunction using a Hamiltonian that characterizes the fermionic quantum system (step 210). The imaginary-time propagation can be performed until predetermined convergence criteria are met, e.g., until output wavefunctions convergence to within a predetermined threshold, where the predetermined threshold can depend on a target accuracy.

At each imaginary time step of the imaginary time propagation, the classical computing device updates the wavefunction for the previous imaginary time step using the classical shadow of the trial wavefunction to obtain a wavefunction for the current imaginary time step. To update the wavefunction for the previous imaginary time step using the classical shadow of the trial wavefunction, the classical computer determines walker wavefunctions for the current time step, e.g., through imaginary time propagation, and determines walker weights for a current time step using i) a first inner product of the trial wavefunction and walker wavefunctions for the previous time step and ii) a second inner product of the trial wavefunction and walker wavefunctions for a current time step, where the first inner product and second inner product are determined using the classical shadow of the trial wavefunction.

Example techniques performed by the system to determine an inner product of a trial wavefunction and a walker wavefunction using a classical shadow include the following. Let |Ψ_{T} [symbol] denote a trial wavefunction. In some implementations |Ψ_{T}) can be chosen to represent fermionic wavefunctions with a definite number of particles η>0 and quantum states that are encoded with the Jordan-Wigner transformation can be used, so that the qubit wavefunction for |Ψ_{T} [symbol] is a superposition of computational basis states with Hamming weight η.

Let |ϕ [symbol] represent a walker wavefunction. The walker wavefunction can be a superposition of computational basis states with Hamming weight η. Computing an inner product of the trial wavefunction and a walker wavefunction can therefore include computing the inner product [symbol] ϕ|Ψ_{T} [symbol] using the classical shadow of the trial wavefunction.

When the quantum computing device prepares a copy of the trial wavefunction at step 202 of example process 200, the quantum computing device can prepare the quantum state |τ [symbol] [symbol] τ| where

$$\vert τ 〉 = \frac{1}{\sqrt{2}} ( \vert 0 〉 + \vert {Ψ}_{T} 〉 ) \qquad ( 19 )$$

where |0 [symbol] represents an all zero state. The inner product (wavefunction overlap) of interest is therefore equal to

$$〈 ϕ \vert {Ψ}_{T} 〉 = 2 〈 ϕ \vert τ 〉 〈 τ \vert 0 〉 = 2 Tr [ \vert τ 〉 〈 τ \vert \cdot \vert 0 〉 〈 ϕ \vert ] \qquad ( 20 )$$

since [symbol] Ψ_{T}|0 [symbol] = [symbol] ϕ|0 [symbol] . Defining the observables

$${P}_{+} = \vert 0 〉 〈 ϕ \vert + \vert ϕ 〉 〈 0 \vert \qquad ( 21 )$$

$${P}_{-} = - i ( \vert 0 〉 〈 ϕ \vert - \vert ϕ 〉 〈 0 \vert ) \qquad ( 22 )$$

$$Re ( 〈 ϕ \vert {Ψ}_{T} 〉 ) = Tr [ \vert τ 〉 〈 τ \vert {P}_{+} ] \qquad ( 23 )$$

$$Im ( 〈 ϕ \vert {Ψ}_{T} 〉 ) = Tr [ \vert τ 〉 〈 τ \vert {P}_{-} ] \qquad ( 24 )$$

where z=Re(z)+Im(z) for z∈ [symbol] . It is noted that Tr[P_{±}]=0, and

$$Tr [ {P}_{\pm }^{2} ] = Tr [ \vert ϕ 〉 〈 ϕ \vert + \vert 0 〉 〈 0 \vert ] = 2 \qquad ( 25 )$$

assuming that |ϕ [symbol] is a normalized wavefunction.

If the ensemble [symbol] used to generate the classical shadow is the Clifford group on N qubits, the inverse of the channel [symbol] can be given by

$${ℳ}^{- 1} ( X ) = ( {2}^{N} + 1 ) X - 𝕀 \qquad ( 26 )$$

where X represents a placeholder variable. Then,

$$Tr [ ( {P}_{+} + i {P}_{i} ) \vert τ 〉 〈 τ \vert ] \approx Tr [ ( {P}_{+} + i {P}_{i} ) {ℳ}^{- 1} ( {U}_{k}^{†} \vert {b}_{k} 〉 〈 {b}_{k} \vert {U}_{k} ) ] = ( {2}^{N} + 1 ) Tr [ ( {P}_{+} + i {P}_{i} ) {U}_{k}^{†} \vert {b}_{k} 〉 〈 {b}_{k} \vert {U}_{k} ] \qquad ( 27 )$$

The full expression for the estimator for the inner product [symbol] ϕ|Ψ_{T} [symbol] then becomes

$$〈 ϕ \vert {Ψ}_{T} 〉 = ( {2}^{N} + 1 ) {𝔼}_{k} \vert Tr [ ( {P}_{+} + i {P}_{i} ) {U}_{k}^{†} \vert {b}_{k} 〉 〈 {b}_{k} \vert {U}_{k} ] ] = 2 ( {2}^{N} + 1 ) {𝔼}_{k} [ 〈 ϕ \vert {U}_{k}^{†} \vert {b}_{k} 〉 〈 {b}_{k} \vert {U}_{k} \vert 0 〉 ] . \qquad ( 28 )$$

Because the inner product [symbol] ϕ|Ψ_{T} [symbol] is expressed in terms of the expectation values of the two operators P_{±} with Tr[P_{±}²]=0(1), the number of state preparation and measurement repetitions required to compute this quantity for target precision is bounded by R=0((log M−log δ)/(∈²)) where M represents the number of different wavefunctions |ϕᵢ [symbol] , ∈ represents the target accuracy and δ represents the target probability that the accuracy ∈ is achieved.

Because the overlap between stabilizer states (including basis states) can be efficiently computed classically, using the Gottesman-Knill theorem, the right-hand side of Eq. 28 can be efficiently computed classically. In particular, [symbol] bₖ|Uₖ|0 [symbol] can be efficiently calculated for

any Clifford circuit Uₖ and since the walker wavefunctions can be written as a linear combination of a polynomial number of stabilizer states, the quantity [symbol] ϕ_{α}|Uₖ^{†}|bₖ [symbol] can be computed for each a in the linear combination and summed together.

As discussed above, shadow tomography using the N-qubit Clifford group can be used to simultaneously estimate M quantities like the one in Eq. 27 at a cost that scales logarithmically in M. However, performing these measurements on a NISQ device can be challenging because of the required circuit depth. Alternative choices of the ensemble of random unitaries [symbol] can alleviate this difficulty. A second choice of [symbol] includes unitaries U∈ [symbol] chosen to be tensor products of single-qubit Clifford operators. Interpolating between these two extremes is also possible. It can be shown that the choice of single-qubit Cliffords for [symbol] leads to bounds on the cost of shadow tomography that scale exponentially with the locality of the operators being estimated. Projectors are highly non-local operators, and therefore it could be expected to see a large number of measurement repetitions required when using single-qubit Clifford shadow tomography to estimate their expectation value (assuming that actual performance correlates with the bounds). This suggests that the tradeoff between circuit depth and the number of repetitions required for performing shadow tomography with different choices of [symbol] should be considered.

To that end, alternative techniques can be implemented to efficiently perform the classical post-processing required to estimate [symbol] β|ψT [symbol] using [symbol] which consist of randomly sampled tensor products of Clifford unitaries on fewer than N qubits. The expression in Eq. 28 can also be written as

$$〈 ϕ \vert {Ψ}_{T} 〉 = 2 {𝔼}_{k} [ 〈 ϕ \vert {ℳ}^{- 1} ( {U}_{k}^{†} \vert {b}_{k} 〉 〈 {b}_{k} \vert {U}_{k} ) \vert 0 〉 ] \qquad ( 29 )$$

An expression similar to that given above in Eq. 26 can be used to apply the inverse channel. For example, consider a partitioning of the N qubits into P parts. Let N₁, N₂, . . . N_{P} be the number of qubits in each part of the partition. Consider a shadow tomography protocol that applies a randomly selected Nₚ-qubit Clifford to each part p∈{1, 2, . . . , P}. This gives

$${U}_{k} = {U}_{k}^{1} ⊗ {U}_{k}^{2} ⊗ … {U}_{k}^{p} \qquad ( 30 )$$

The inverse of the shadow tomography measurement channel is

$${ℳ}_{P a r}^{- 1} = {⊗}_{p = 1}^{P} {ℳ}_{{N}_{p}}^{- 1} \qquad ( 31 )$$

where, as in Eq. 26,

$${ℳ}_{{N}_{p}}^{- 1} ( X ) = ( {2}^{{N}_{p}} + 1 ) X - {𝕀}_{{N}_{p}} \qquad ( 32 )$$

where X represents a placeholder variable. If |ϕ [symbol] is a computational basis state denoted by |β [symbol] , where |βₚ [symbol] represents a component of |β [symbol] associated with the p-th part of the partition, then Eq. 28 can be evaluated to give

$$〈 β \vert {Ψ}_{T} 〉 = 2 {𝔼}_{k} [ {\prod }_{p = 1}^{P} ( {2}^{{N}_{p}} + 1 ) 〈 {β}_{p} \vert ( {U}_{k}^{p †} \vert {b}_{k}^{p} 〉 〈 {b}_{k}^{p} \vert {U}_{k}^{p} ) \vert {0}_{p} 〉 - 〈 {β}_{p} \vert {0}_{p} 〉 ] . \qquad ( 33 )$$

In some implementations the partition can include two parts, one for each spin sector. In implementations where the walker wavefunctions are superpositions of basis states with Hamming weight η and a nonzero number of electrons in each spin sector, shadow tomography can be used to evaluate the overlap of the walker wavefunctions with the trial wavefunction with [symbol] βₚ|0 [symbol] =0. Because of this, the inner products can be classically computed as

$$〈 ϕ \vert {Ψ}_{T} 〉 = {\sum }_{i} {c}_{i} 〈 {β}^{i} \vert {Ψ}_{T} 〉 = {\sum }_{i} {c}_{i} 2 {𝔼}_{k} [ {\prod }_{p = 1}^{P} ( {2}^{{N}_{p}} + 1 ) 〈 {β}_{p}^{i} \vert ( {U}_{k}^{p †} \vert {b}_{k}^{p} 〉 〈 {b}_{k}^{p} \vert {U}_{k}^{p} ) \vert {0}_{p} 〉 ] . \qquad ( 34 )$$

where cᵢ represents amplitudes of |ϕ [symbol] in the computational basis {|βⁱ [symbol] }.

Returning to step 210 of FIG. 2, to determine walker weights for a current time step using the first inner product of the trial wavefunction and walker wavefunctions for the previous time step and the second inner product of the trial wavefunction and walker wavefunctions for a current time step, the classical computer retrieves the classical shadow of the trial wavefunction from the classical memory, e.g., retrieves data corresponding to Eq. 14. The classical computer then computes an approximation of the first inner product by determining expectation values of one or more classically simulated first projectors and the classical shadow of the trial wavefunction, e.g., expectation values given by Eq. 28. The one or more first projectors are dependent on the walker wavefunctions for the previous time step. That is, the classical computer computes the first inner product [symbol] Ψ_{T}|ψₙ(τ) [symbol] using Eq. 19-28 or 29-34. As described above with reference to Eq. 19-28, the one or more first projectors can be generated using stabilizer states, where the stabilizer states comprise a computational basis state with a Hamming weight equal to the number of particles represented by the trial wavefunction. The classical computer performs similar operations to compute the second inner product [symbol] Ψ_{T}|ψₙ(τ+Δτ) [symbol] .

At each imaginary time step of the imaginary time propagation the classical computer also computes an energy estimator, e.g., given by Eq. 3, using the classical shadow of the trial wavefunction. In some implementations a ground state energy is estimated from a time series of the energy estimators computed at each imaginary time step.

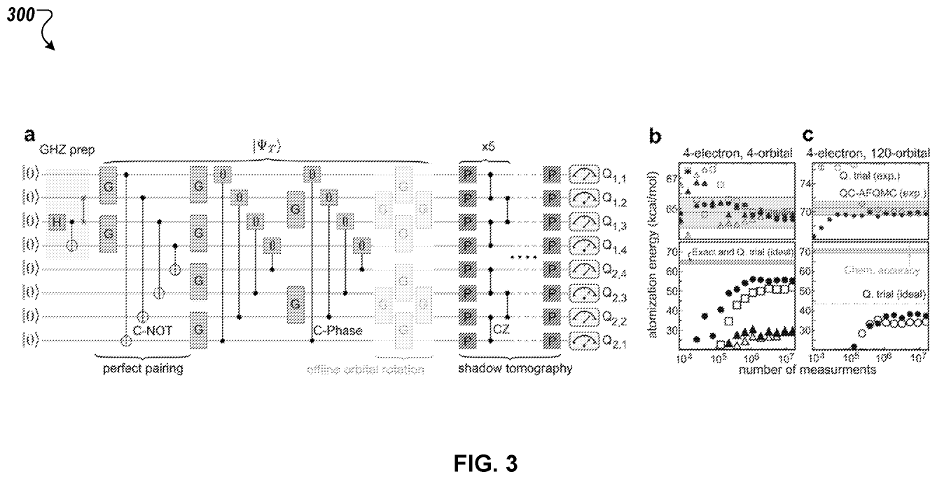

FIG. 3 shows an application of the presently described QC-QMC algorithm to an H₄ molecule in an 8-qubit experiment. In this example, an eight spin-orbital quantum trial wavefunction is used. The trial wavefunction consists of a valence bond wavefunction known as a perfect pairing state and a hardware-efficient quantum circuit with an offline single-particle rotation is applied to this. It would be classically difficult to use this as a trial wavefunction for AFQMC.

Part (a) of FIG. 3 shows an example state preparation circuit for preparing the trial wavefunction using a quantum computer. In this 8-qubit experiment, H₄ in a square geometry with side lengths of 1.23 A and its dissociation into four hydrogen atoms is considered. This system can be used as a testbed for electron correlation methods in quantum chemistry. Part (a) shows the experimental circuit used for the experiment over a 2×4 qubit grid. In the circuit diagram, H denotes the Hadamard gate, G denotes a Givens rotation gate (generated by Pauli gates (XX+YY), P denotes a Pauli gate, and |Ψ_{T} [symbol] denotes the quantum trial wavefunction. The offline orbital rotation is not present in the actual quantum circuit because they can be efficiently handled via classical post-processing.

Part (b) and (c) of FIG. 3 show the convergence of the atomization energy of H₄ as a function of the number of measurements. Part (b) shows a minimal basis set (STO-3G) with four orbitals total from four independent experiments with different sets of random measurements and part (c) shows a quadruple-zeta basis set (cc-pVQZ) with 120 orbitals total from two independent experiments. The different symbols in (b) and (c) show independent experimental results. The top panels of (b) and (c) magnify the energy range near the exact answer. As shown, the noise

on the quantum device makes the quality of the quantum trial far from that of the ideal (i.e., noiseless) ansatz, resulting in an error as large as 10 kcal/mol in the atomization energy. Nonetheless, the presently described QC-AFQMC reduces this error significantly, and achieves
chemical accuracy in both bases. To unravel the QC-AFQMC results on H₄ further, parts (b) and (c) show the evolution of trial and QC-AFQMC energies as a function of the number of measurements made on the device. Despite the presence of significant noise within approximately 105 measurements, QC-AFQMC achieves chemical accuracy while coping with a sizeable residual bias in the underlying quantum trial.

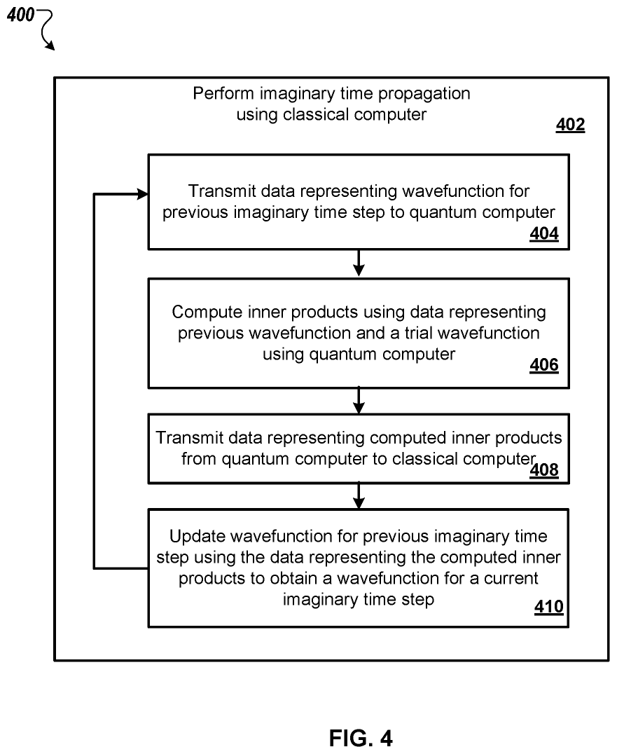

FIG. 4 is a flow diagram of an example process 400 for performing a Quantum Monte Carlo simulation of a fermionic quantum system to compute a target wavefunction of the fermionic quantum system and/or properties of the target wavefunction, e.g., a ground wavefunction energy. In some implementations the Quantum Monte Carlo simulation can be a Projector Quantum Monte Carlo simulation, e.g., an Auxiliary-field Quantum Monte Carlo simulation. For convenience, the process 400 will be described as being performed by a system that includes classical and quantum computing devices located in one or more locations. For example, system 100 of FIG. 1, appropriately programmed in accordance with this specification, can perform the process 400.

A classical computer included in the system performs imaginary time propagation (for a sequence of imaginary time steps) of an initial wavefunction using a Hamiltonian that characterizes the fermionic quantum system (step 402). The imaginary time propagation is performed until predetermined convergence criteria are met, e.g., until outputs converge to within a predetermined threshold.

Each imaginary time step of the imaginary time propagation includes the following steps. The classical computer transmits data representing a wavefunction for the previous imaginary time step to a quantum computer, e.g., a NISQ device (step 404). The quantum computer computes inner products using the data representing the wavefunction for the previous wavefunction and a trial wavefunction that approximates the target wavefunction (step 406). Example trial wavefunctions are described above with reference to FIG. 1.

The classical computer receives data representing the computed inner products generated by the quantum computer (step 408) and updates the wavefunction for the previous imaginary time step using the data representing the computed inner products to obtain a wavefunction for the current imaginary time step (step 410). The classical computer can also compute an energy estimator using the classical shadow of the trial wavefunction, e.g., compute Eq. 3.

In some implementations the classical computer updates the wavefunction for the previous imaginary time step using the data representing the computed inner products to obtain a wavefunction for the current imaginary time step by determining walker wavefunctions for the current time step and determining walker weights for a current time step using the computed inner products, where the computed inner products comprise a first inner product of the trial wavefunction and walker wavefunctions for the current time step and a second inner product of the trial wavefunction and walker wavefunctions for a previous time step. That is, the classical computer updates the wavefunction for the previous imaginary time step using Eq. 3-6, where the inner products are computed by the quantum computer. In these implementations the data representing a wavefunction for the previous imaginary time step transmitted from the classical computer to the quantum computer includes data representing walker wavefunctions for the previous imaginary time step and data representing the computed walker wavefunctions for the current imaginary time step (e.g., computed by the classical computer through imaginary time propagation).

The quantum computer can then computes the inner products using the data representing the walker wavefunctions for the previous imaginary time step, data representing the computed walker wavefunctions for the current imaginary time step, and the trial wavefunction.

The quantum computer can compute the inner products using projective measurements on the trial wavefunction, where projectors of the projective measurements are generated using stabilizer states. The stabilizer states can include a computational basis state with a Hamming weight equal to the number of particles represented by the trial wavefunction. Projectors of the projective measurements can be determined by the data representing the walker wavefunctions for the previous imaginary time step or data representing the computed walker wavefunctions for the current imaginary time step. Computing the inner products and the projective measurements that can be performed by the quantum computer are described above with reference.

FIG. 5 depicts an example classical/quantum computer 500 for performing some or all of the classical and quantum operations described in this specification. The example classical/quantum computer 500 includes an example quantum computing device 502. The quantum computing device 502 is intended to represent various forms of quantum computing devices. The components shown here, their connections and relationships, and their functions, are exemplary only, and do not limit implementations of the inventions described and/or claimed in this document.

The example quantum computing device 502 includes a qubit assembly 552 and a control and measurement system 504. The qubit assembly includes multiple qubits, e.g., qubit 506, that are used to perform algorithmic operations or quantum computations. While the qubits shown in FIG. 5 are arranged in a rectangular array, this is a schematic depiction and is not intended to be limiting. The qubit assembly 552 also includes adjustable coupling elements, e.g., coupler 508, that allow for interactions between coupled qubits. In the schematic depiction of FIG. 5, each qubit is adjustably coupled to each of its four adjacent qubits by means of respective coupling elements. However, this is an example arrangement of qubits and couplers and other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 502 included in the example computer 500 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits may be realized via superconducting qubits or semi-conducting qubits, e.g., superconducting transmon states. As another example, in a NMR quantum computer the qubits may be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits, e.g., to implement the quantum circuits required for shadow tomography, as described above with reference to FIG. 1. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), iSWAP gates, and gates involving three or more qubits, e.g., Toffoli gates. The quantum logic gates can be implemented by applying control signals 510 generated by the control and measurement system 504 to the qubits and to the couplers.

For example, in some implementations the qubits in the qubit assembly 552 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 510 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 510. The measurements cause readout signals 512 representing measurement results to be communicated back to the measurement and control system 504. The readout signals 512 may include RF, microwave, or optical signals depending on the physical scheme for the quantum computing device and/or the qubits. For convenience, the control signals 510 and readout signals 512 shown in FIG. 5 are depicted as addressing only selected elements of the qubit assembly (i.e. the top and bottom rows), but during operation the control signals 510 and readout signals 512 can address each element in the qubit assembly 552.

The control and measurement system 504 is an example of a classical computer system that can be used to perform various operations on the qubit assembly 552, as described above, as well as other classical subroutines or computations. The control and measurement system 504 includes one or more classical processors, e.g., classical processor 514, one or more memories, e.g., memory 516, and one or more I/O units, e.g., I/O unit 518, connected by one or more data buses. The control and measurement system 504 can be programmed to send sequences of control signals 510 to the qubit assembly, e.g. to carry out a selected series of quantum gate operations, and to receive sequences of readout signals 512 from the qubit assembly, e.g. as part of performing measurement operations.

The processor 514 is configured to process instructions for execution within the control and measurement system 504. In some implementations, the processor 514 is a single-threaded processor. In other implementations, the processor 514 is a multi-threaded processor. The processor 514 is capable of processing instructions stored in the memory 516.

The memory 516 stores information within the control and measurement system 504. In some implementations, the memory 516 includes a computer-readable medium, a volatile memory unit, and/or a non-volatile memory unit. In some cases, the memory 516 can include storage devices capable of providing mass storage for the system 504, e.g. a hard disk device, an optical disk device, a storage device that is shared over a network by multiple computing devices (e.g., a cloud storage device), and/or some other large capacity storage device.

The input/output device 518 provides input/output operations for the control and measurement system 504. The input/output device 518 can include D/A converters, A/D converters, and RF/microwave/optical signal generators, transmitters, and receivers, whereby to send control signals 510 to and receive readout signals 512 from the qubit assembly, as appropriate for the physical scheme for the quantum computer. In some implementations, the input/output device 518 can also include one or more network interface devices, e.g., an Ethernet card, a serial communication device, e.g., an RS-232 port, and/or a wireless interface device, e.g., an 802.11 card. In some implementations, the input/output device 518 can include driver devices configured to receive input data and send output data to other external devices, e.g., keyboard, printer and display devices.

Although an example control and measurement system 504 has been depicted in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The example system 500 also includes an example classical processor 550. The classical processor 550 can be used to perform classical computation operations described in this specification according to some implementations.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g. photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results.

As one example, the processes depicted in the accompanying figures do not necessarily require the particular order shown, or sequential order, to achieve desirable results. In some cases, multitasking and parallel processing may be advantageous.

What is claimed is:

1. A computer implemented method for performing a Quantum Monte Carlo simulation of a fermionic quantum system to compute a target wavefunction of the fermionic quantum system, the method comprising:
receiving, by a classical computer, data generated by a quantum computer, the data representing results of one or more measurements of a trial wavefunction, wherein the trial wavefunction approximates the target wavefunction and is prepared by the quantum computer;
computing, by the classical computer, a classical shadow of the trial wavefunction using the data representing the results of the one or more measurements of the trial wavefunction; and
performing, by the classical computer, imaginary time propagation for a sequence of imaginary time steps of an initial wavefunction using a Hamiltonian that characterizes the fermionic quantum system, wherein:
the imaginary time propagation is performed until predetermined convergence criteria are met; and
performing each imaginary time step of the imaginary time propagation comprises updating the wavefunction for the previous imaginary time step using the classical shadow of the trial wavefunction to obtain a wavefunction for the current imaginary time step.

2. The method of claim 1, wherein updating the wavefunction for the previous imaginary time step using the classical shadow of the trial wavefunction comprises:
determining walker wavefunctions for the current imaginary time step; and
determining walker weights for a current imaginary time step using a first inner product of the trial wavefunction and walker wavefunctions for the previous imaginary time step and a second inner product of the trial wavefunction and walker wavefunctions for a current imaginary time step, wherein the first inner product and second inner product are determined using the classical shadow of the trial wavefunction.

3. The method of claim 1, further comprising storing the computed classical shadow of the trial wavefunction in a classical memory of the classical computer.

4. The method of claim 3, wherein determining walker weights for a current imaginary time step using the first inner product of the trial wavefunction and walker wavefunctions for the previous imaginary time step and the second inner product of the trial wavefunction and walker wavefunctions for a current imaginary time step comprises:
retrieving the classical shadow of the trial wavefunction from the classical memory;
computing an approximation of the first inner product, comprising determining expectation values of one or more classically simulated first projectors and the classical shadow of the trial wavefunction, wherein the one or more first projectors are dependent on the walker wavefunctions for the previous imaginary time step; and
computing an approximation of the second inner product, comprising determining expectation values of one or more classically simulated second projectors and the classical shadow of the trial wavefunction, wherein the one or more second projectors are dependent on the walker wavefunctions for the current imaginary time step.

5. The method of claim 4, wherein the one or more first projectors are generated using stabilizer states.

6. The method of claim 5, wherein the stabilizer states comprise a computational basis state with a Hamming weight equal to the number of particles represented by the trial state.

7. The method of claim 1, wherein the trial wavefunction comprises a trial wavefunction rotated using a unitary operator randomly sampled from an ensemble of unitaries, wherein the ensemble of unitaries is tomographically complete.

8. The method of claim 7, wherein the unitary operator comprises an N-qubit Clifford circuit or a tensor product of randomly selected Clifford circuits on less than N qubits.

9. The method of claim 1, wherein performing each imaginary time step of the imaginary time propagation further comprises computing an energy estimator using the classical shadow of the trial wavefunction.

10. The method of any claim 1, wherein the trial wavefunction comprises a trial wavefunction transformed using a tensor product of unitary operators, wherein each unitary operator in the tensor product comprises a respective randomly selected N_{p∈P}-qubit Clifford gate, wherein N_{p∈P} represents a number of qubits in part p of a partitioning of N qubits into P parts.

11. The method of claim 1, further comprising:
preparing, by a quantum computer, multiple copies of the trial wavefunctions, wherein the trial wavefunction approximates the target wavefunction;
performing, by the quantum computer, measurement operations on transformations of the multiple copies of the trial wavefunctions; and
transmitting, by the quantum computer and to the classical computer, data representing results of the measurement operations.

12. A computer implemented method for performing a Quantum Monte Carlo simulation of a fermionic quantum system to compute a target wavefunction of the fermionic quantum system, the method comprising:
preparing, by a quantum computer, multiple copies of a trial wavefunctions, wherein the trial wavefunction approximates the target wavefunction;
performing, by the quantum computer, measurement operations on transformations of the multiple copies of the trial wavefunctions; and
transmitting, by the quantum computer and to a classical computer, data representing results of the measurement operations, wherein the classical computer performs imaginary time propagation of an initial wavefunction using a Hamiltonian that characterizes the fermionic quantum system using the transmitted data.

13. The method of claim 12, wherein performing a measurement operation on a transformation of a copy of the trial wavefunction comprises:
randomly sampling a unitary operator from an ensemble of unitary operators, wherein the ensemble of unitary operators is tomographically complete;
applying the randomly sampled unitary operator to the copy of the trial wavefunction to obtain a rotated trial wavefunction; and
measuring the rotated trial wavefunction in the computational basis.

14. The method of claim 12, wherein performing a measurement operation on a transformation of a copy of the trial wavefunction comprises:
randomly sampling multiple unitary operators from an ensemble of unitary operators, wherein the ensemble of unitary operators is tomographically complete and wherein each sampled unitary operator comprises an N_{p∈P}-qubit Clifford gate, wherein N_{p∈P} represents a number of qubits in part p of a partitioning of N qubits into P parts;
applying a tensor product of the randomly sampled unitary operators to the copy of the trial wavefunction to obtain a transformed trial wavefunction; and
measuring the transformed trial wavefunction in the computational basis.

15. The method of claim 12, wherein the Quantum Monte Carlo simulation comprises an Projector Quantum Monte Carlo simulation or an Auxiliary-field Quantum Monte Carlo simulation.

16. The method of claim 12, wherein the quantum computer comprises a Noisy Intermediate Scale Quantum device.

17. The method of claim 12, wherein the trial wavefunction comprises a wavefunction from a generalized valence bond perfect-pairing wavefunction ansatz.

18. The method of claim 17, wherein the generalized valence bond perfect-pairing wavefunction ansatz comprises a first set of layers comprising density-density product terms and a second set of layer comprising nearest-neighbor hopping terms between same spin pairs.

19. A system comprising:
one or more computers; and
one or more computer-readable media coupled to the one or more computers having instructions stored thereon which, when executed by the one or more computers, cause the one or more computers to perform operations comprising:
receiving, by a classical computer, data generated by a quantum computer, the data representing results of one or more measurements of a trial wavefunction, wherein the trial wavefunction approximates the target wavefunction and is prepared by the quantum computer;
computing by the classical computer, a classical shadow of the trial wavefunction using the data representing the results of the one or more measurements of the trial wavefunction; and performing, by the classical computer, imaginary time propagation for a sequence of imaginary time steps of an initial wavefunction using a Hamiltonian that characterizes the fermionic quantum system, wherein:
the imaginary time propagation is performed until predetermined convergence criteria are met; and
performing each imaginary time step of the imaginary time propagation comprises updating the wavefunction for the previous imaginary time step using the classical shadow of the trial wavefunction to obtain a wavefunction for the current imaginary time step.

20. A system comprising:
one or more quantum computers; and
one or more computer-readable media coupled to the one or more quantum computers having instructions stored thereon which, when executed by the one or more quantum computers, cause the one or more quantum computers to perform operations comprising:
preparing by a quantum computer, multiple copies of a trial wavefunctions, wherein the trial wavefunction approximates the target wavefunction;
performing, by the quantum computer, measurement operations on transformations of the multiple copies of the trial wavefunctions; and
transmitting, by the quantum computer and to a classical computer, data representing results of the measurement operations, wherein the classical computer performs imaginary time propagation of an initial wavefunction using a Hamiltonian that characterizes the fermionic quantum system using the transmitted data.

21. The system of claim 20, wherein the quantum computer comprises a NISQ device.
